(19) United States
(12) Patent Application Publication
(10) Pub. No.: US 2020/0113206 A1
(43) Pub. Date: Apr. 16, 2020

(54) Soybean-Derived Composition and Method for Producing Same

(71) Applicant: Sapporo Holdings Limited, Tokyo (JP)

(72) Inventors: Norihiko Tsuchimoto, Shibuya-ku, Tokyo (JP); Shinji Yamashita, Shibuya-ku, Tokyo (JP)

(73) Assignee: Sapporo Holdings Limited, Tokyo (JP)

(21) Appl. No.: 16/603,895

(22) PCT Filed: Feb. 5, 2018
(86) PCT No.: PCT/JP2018/003789

§ 371 Date: Oct. 9, 2019

(30) Foreign Application Priority Data
Apr. 11, 2017 (JP) 2017-078415

(51) Int. Cl. A23J 1/14; A23J 3/16; A23C 11/10

(52) U.S. Cl. CPC A23J 1/148; A23C 11/106; A23J 3/16

(57) ABSTRACT

The present invention relates to a soybean-derived composition, wherein a content of lipids as a chloroform/methanol mixed solvent extract is 40% by mass or more based on dry matter, and wherein the composition is substantially free of β-conglycinin.

### TECHNICAL FIELD

The present invention relates to a soybean-derived composition and a method for producing the same.

### BACKGROUND ART

Soy milk produced by processing soybeans contains an abundant amount of nutritional components derived from soybeans, in addition to being low in calories and cholesterols, and is known as a healthy food.

A soybean-derived composition in which the lipid content in soy milk is increased attracts attention as a food material which can be substituted for dairy products represented by fresh cream in recent years. For example, a soybean emulsified composition obtained by using thermally denatured soybeans as a raw material, separating and collecting from its suspension as an insoluble fraction containing lipids is disclosed in Patent Literature 1.

### CITATION LIST

### Patent Literature

Patent Literature 1: Japanese Patent No. 5887714

### SUMMARY OF INVENTION

### Technical Problem

However, the present inventors have found the following problem: the soybean emulsified composition obtained by the method described in Patent Literature 1 has insufficient oiliness (oil and fat texture) felt when it is in the mouth.

The present invention has been devised in view of the circumstance described above, and objects thereof are to provide a soybean-derived composition which enables feeling an oil and fat texture enough and has high lipid and a method for producing the same.

### Solution to Problem

The present invention provides a soybean-derived composition, wherein the content of lipids as a chloroform/methanol mixed solvent extract is 40% by mass or more based on dry matter, and wherein the composition is substantially free of β-conglycinin. The soybean-derived composition of the present invention enables feeling an oil and fat texture enough by adopting the above-mentioned constitution.

It is preferable that the above-mentioned soybean-derived composition be substantially free of glycinin in addition to β-conglycinin. An oil and fat texture of the soybean-derived composition is felt more strongly thereby.

The present invention also provides a method for producing a soybean-derived composition, comprising: a suspension preparation step of adding water to soybeans to obtain a suspension; and an enzyme treatment step A of treating the suspension with a protease to obtain a lipid-containing fraction A. Since the production method of the present invention comprises the suspension preparation step and the enzyme treatment step A, lipids can be efficiently collected from soybeans, a soybean-derived composition which enables feeling an oil and fat texture enough and has high lipid can be obtained.

In the aforementioned production method, it is preferable that the protease be a plant-derived protease. Thereby, the lipid content of the soybean-derived composition can be further increased.

The aforementioned production method may further comprise an enzyme treatment step B of treating the lipid-containing fraction A with an exopeptidase to obtain a lipid-containing fraction B. Thereby, the bitter taste of a soybean-derived composition can be reduced.

The aforementioned production method may further comprise a centrifugation step C of centrifuging the lipid-containing fraction B at 0 to 10° C. to obtain a lipid-containing fraction C. Thereby, the bitter taste of the soybean-derived composition is further reduced.

### Advantageous Effects of Invention

According to the present invention, a soybean-derived composition which enables feeling an oil and fat texture enough and has high lipid and a method for producing the same can be provided. According to the present invention, a soybean-derived composition in which the bitter taste is reduced and a method for producing the same can be provided.

### BRIEF DESCRIPTION OF DRAWING

FIG. 1 (a) is a photograph showing the analysis results of proteins contained in a suspension and a lipid-containing fraction C obtained in Example 3; a lipid-containing fraction A obtained in Example 4; and commercial soy milk cream by SDS-PAGE. FIG. 1 (b) is a photograph showing the analysis results of proteins contained in a suspension and a lipid-containing fraction C obtained in Example 3; a lipid-containing fraction A obtained in Example 4; and commercial soy milk cream by Western blotting. In (a) and (b), a lane 1 and a lane 6 are the analysis results of a molecular weight marker, a lane 2 is the analysis result of the suspension obtained in Example 3, a lane 3 is the analysis result of the lipid-containing fraction C obtained in Example 3, a lane 4 is the analysis result of the commercial soy milk cream, a lane 5 is the analysis result of the lipid-containing fraction A obtained in Example 4.

### DESCRIPTION OF EMBODIMENTS

Hereinafter, embodiments for carrying out the present invention will be described in detail. However, the present invention is not limited to the following embodiments.

[1. Soybean-Derived Composition]

The soybean-derived composition according to the present embodiment is a composition derived from soybeans wherein the content of lipids (neutral lipids and polar lipids) is comparatively high and the composition is substantially free of a specific protein substantially; and is characterized in that the content of lipids as a chloroform/methanol mixed solvent extract is 40% by mass or more based on dry matter, and the composition is substantially free of β-conglycinin.

In this description, the “lipid content” is a lipid content measured according to the method for extracting with a chloroform and methanol mixed liquid stipulated in “Shokuhin Hyoji Kijun nitsuite, Betten, Eiyo-seibun-nado no Bunseki-houhou-nado” (“Methods for analyzing nutrient components and the like, and the like, attachment to Food labeling standards” in Japanese) (Mar. 30, 2015, Shoushoku hyo, No. 139), and a value obtained by calculating the amount of an extract extracted from the soybean-derived composition at normal pressure and the boiling point for 1 hour using a mixed solvent of chloroform and methanol (volume ratio 2:1) as the total lipid content is specifically defined as a lipid content. That is, the lipid content herein means the total lipid content as a chloroform/methanol mixed solvent extract content.

The lipid content of the soybean-derived composition according to the present embodiment may be 40% by mass or more based on dry matter as a chloroform/methanol mixed solvent extract, and it is preferable that the lipid content be 50% by mass or more based on dry matter, and it is more preferable that lipid content be 60% by mass or more based on dry matter from the viewpoint of increasing the lipid content of a soybean-derived composition further so that an oil and fat texture is felt more strongly. Although the upper limit of the lipid content is not particularly limited, it may be, for example, 99% by mass or less or 95% by mass or less from the viewpoint of flavor. The lipid content of the soybean-derived composition can be adjusted to the above-mentioned range by appropriately setting the type or the added amount of a protease used in the enzyme treatment step A in the below-mentioned [2. Method for producing soybean-derived composition], enzyme treatment conditions or the like; or the type of soybeans used in the suspension preparation steps in the below-mentioned [2. Method for producing soybean-derived composition], the used amount, immersion conditions or the like.

The soybean-derived composition according to the present embodiment is substantially free of β-conglycinin. β-Conglycinin is one of main components of proteins contained in soybeans, and is a protein wherein it comprises at least three types of subunits (α, α′ and β), and the molecular weight is around 180 kDa. When the soybean-derived composition is substantially free of polymeric β-conglycinin, an oil and fat texture is felt strongly.

β-Conglycinin in the soybean-derived composition can be detected, for example, by performing SDS polyacrylamide gel electrophoresis (SDS-PAGE) and then confirming the depth of the bands equivalent to subunits constituting β-conglycinin. For a detection method with higher precision, the detection can be conducted by performing Western blotting using a β-conglycinin antibody and then confirming the depth of the bands equivalent to the subunits constituting β-conglycinin. For determining whether β-conglycinin is contained or not, for example, when the detection of β-conglycinin is the detection limit or less in SDS-PAGE using a sample of the soybean-derived composition wherein the protein concentration of the sample to be examined is 22% by mass, the sample is determined to be substantially free of β-conglycinin, and preferably, when the detection of β-conglycinin is the detection limit or less by Western blotting using a sample of the soybean-derived composition wherein the protein concentration of the sample to be examined is 22% by mass, the sample is determined to be substantially free of β-conglycinin.

In the enzyme treatment step A in the below-mentioned [2. Method for producing soybean-derived composition], the soybean-derived composition can be substantially free of β-conglycinin by setting the type or the added amount of a protease to be used, enzyme treatment conditions or the like.

The β-conglycinin content per protein of the soybean-derived composition according to the present embodiment may be 0.1% by mass or less, 0.01% by mass or less, or 0.005% by mass or less. It is preferable that the soybean-derived composition according to the present embodiment be free of β-conglycinin. The β-conglycinin content per protein can be found, for example, by calculating the ratio of the depth of bands equivalent to the subunits constituting β-conglycinin to the depth of the bands of all the proteins in SDS-PAGE using a sample of the soybean-derived composition.

It is preferable that the soybean-derived composition according to the present embodiment be substantially free of glycinin. Glycinin is one of main components of the proteins contained in soybeans, and is a protein wherein it comprises at least 12 types of subunits (acidic subunits A1 to A6 and basic subunits B1 to B6), and the molecular weight is around 320 to 360 kDa. When the soybean-derived composition is free of polymeric glycinin, an oil and fat texture is felt more strongly. Glycinin in the soybean-derived composition can be detected, for example, by performing SDS-PAGE and then confirming the depth of bands equivalent to the subunits constituting glycinin. For a detection method with higher precision, the detection can be conducted by performing Western blotting using a glycinin antibody and then confirming the depth of the bands equivalent to the subunits constituting glycinin. For determining whether glycinin is contained or not, for example, when the detection of glycinin is the detection limit or less by SDS-PAGE using a sample of the soybean-derived composition wherein the protein concentration of the sample to be examined is 22% by mass, the sample is determined to be substantially free of glycinin, and preferably, when the detection of glycinin is the detection limit or less by Western blotting using a sample of the soybean-derived composition wherein the protein concentration of the sample to be examined is 22% by mass, the sample is determined to be substantially free of glycinin.

In the enzyme treatment step A in the below-mentioned [2. Method for producing soybean-derived composition], the soybean-derived composition can be substantially free of glycinin by setting the type or the added amount of a protease to be used, enzyme treatment conditions or the like.

The glycinin content per protein of the soybean-derived composition according to the present embodiment may be 0.1% by mass or less, 0.01% by mass or less, or 0.005% by mass or less. It is preferable that the soybean-derived composition according to the present embodiment be free of glycinin. The glycinin content per protein can be found, for example, by calculating the ratio of the depth of bands equivalent to the subunits constituting glycinin to the depth of the bands of all the proteins in SDS-PAGE using a sample of the soybean-derived composition.

The soybean-derived composition according to the present embodiment can be used as foods and beverages (soy milk cream) as it is since it contains nutrient components derived from soybeans abundantly, and an oil and fat texture is felt enough.

In addition, since the soybean-derived composition according to the present embodiment is substantially free of polymeric proteins such as β-conglycinin, the viscosity is reduced. Therefore, since the soybean-derived composition according to the present embodiment has slight influence on texture, the wide application as a food material is expected.

It is known that the IgE of some patients suffering from soybean allergies recognizes β-conglycinin as an allergen. Therefore, the soybean-derived composition according to the present embodiment, which is substantially free of β-conglycinin, can be used also as low-allergen foods and beverages or a low-allergen food material.

[2. Method for Producing Soybean-Derived Composition]

A method for producing a soybean-derived composition according to the present embodiment comprises at least a suspension preparation step of adding water to soybeans to obtain a suspension and an enzyme treatment step A of treating the suspension with a protease. The method for producing a soybean-derived composition according to the present embodiment may further comprise an enzyme treatment step B, a centrifugation step C, a sterilization treatment step and/or an addition step. The steps will be described hereinafter.

(Suspension Preparation Step)

A suspension preparation step is a step of adding water to soybeans to obtain a suspension. The suspension preparation step can be performed, for example, by grinding soybeans to which water (preferably warmed water) is added using a commercial mixer or the like. The present inventors have newly found that the lipid recovery from the suspension is high as compared with the lipid recovery from commercial soy milk as described in the below-mentioned Examples 2 and 3. Therefore, lipids can be efficiently recovered from soybeans by the implementation of this step. Fibrous material in the above-obtained suspension may be removed by filtration or the like if needed.

In the suspension preparation step, it is preferable that soybeans, after addition of water, be immersed before grinding. Thereby, the lipid recovery from soybeans further improves. The immersing temperature can be appropriately adjusted depending on the temperature, the water content in the soybeans, or the like, and may be, for example, 40 to 90° C., and since the lipid recovery from soybeans can be further improved, it is preferable that the immersing temperature be 60 to 70° C. The immersing time can be appropriately adjusted depending on the immersing temperature, the water content in the soybeans, or the like, and may be, for example, 90 to 180 minutes.

Although either of an untreated soybeans and peeled soybeans may be used for soybeans to be used in the suspension preparation step, it is preferable to use peeled soybeans from the viewpoint of smoothing the texture of the obtained soybean-derived composition. The variety of soybeans is not particularly limited, and all varieties of soybeans can be used.

(Enzyme Treatment Step A)

An enzyme treatment step A is a step of treating the suspension obtained in the above-mentioned suspension preparation step with a protease to obtain a lipid-containing fraction A. The enzyme treatment step A can be specifically performed by adding the protease to the suspension and hydrolyzing proteins or peptide chains contained in the suspension. Lipids in the suspension separates easily as a concentrated lipid-containing fraction by implementing this step, and the lipid content of the soybean-derived composition can be increased. In the enzyme treatment step A, soy milk may be used instead of the suspension obtained in the above-mentioned suspension preparation step. That is, “a method for producing a soybean-derived composition comprising an enzyme treatment step A of treating soy milk with a protease to obtain a lipid-containing fraction A” is included in the present embodiment. Here, “soy milk” means a milky beverage obtained by eluting proteins and other components from soybeans with hot water or the like and removing fibrous material. Commercial soybean milk can also be used.

In the enzyme treatment step A, lipid-containing fractions A in different forms can be obtained by adjusting the type of a protease to be used, the enzyme activity or the like. For example, when a protease wherein the enzyme activity is comparatively high is used, lipids in the suspension separate by the hydrolysis of proteins and float, and the floating layer can therefore be collected as a lipid-containing fraction A. Meanwhile, when a protease wherein the enzyme activity is comparatively low is used, partially hydrolyzed proteins form hydrophobic bonds, aggregate with lipids in the suspension and precipitate, and a precipitation layer can therefore be collected as a lipid-containing fraction A.

Examples of the protease to be used in the enzyme treatment step A include plant-derived proteases such as papain (Papain W-40 (produced by Amano Enzyme Inc.)), Sumizyme S (produced by SHINNIHON CHEMICALS Corporation), bromelain (Bromelain F (produced by Amano Enzyme Inc.)); and bacteria-derived proteases such as a protease derived from genus Bacillus (Protin NY100 (produced by Amano Enzyme Inc.)). The protease may be used alone or in combination of two or more. Since plant-derived proteases are excellent in effect of concentrating lipids among proteases, they are preferable. Proteases are classified into an exo-type which cuts 1 or 2 amino acid residues from a terminus of the sequence of a protein or a peptide chain and an endo-type which cuts the inside of the sequence of a protein or a peptide chain, and since the endo-type proteases are excellent in effect of concentrating lipids, they are preferable. In enzyme treatment step A, enzymes other than the protease may further be added if needed.

The added amount of the protease can be appropriately adjusted depending on the type of the protease to be used, or the like. When the floating layer is collected as a lipid-containing fraction A, the added amount of the protease may be, for example, 10 ppm to 100 ppm based on 1 g of the suspension. When the precipitation layer is collected as a lipid-containing fraction A, the added amount of the protease may be, for example, 100 ppm to 3000 ppm based on 1 g of the suspension.

The treating temperature and treating time of the suspension in the enzyme treatment step A can be appropriately adjusted depending on the type and the added amount of a protease to be used, and the like, and can be, for example, 50 to 70° C. and 30 to 120 minutes.

The protease in the lipid-containing fraction A may be deactivated by heating and the like after the enzyme treatment step A if needed. The heating temperature and heating time can be appropriately adjusted depending on the type of the protease, and can be, for example, 70 to 100° C. and 10 to 120 minutes. The lipid-containing fraction A may be washed by centrifugation or the like after the enzyme treatment step A if needed.

(Enzyme Treatment Step B)

An enzyme treatment step B is a step of treating the above-mentioned lipid-containing fraction A with an exopeptidase to obtain a lipid-containing fraction B. The enzyme treatment step B can be specifically performed by adding the exopeptidase to the above-mentioned lipid-containing fraction A and hydrolyzing near termini of peptide chains contained in the lipid-containing fraction A. The present inventors have found a problem that since peptides produced by protease treatment in the enzyme treatment step A and having mainly hydrophobic amino acids at the termini (bitter peptides) are contained in the above-mentioned lipid-containing fraction A, a bitter taste is felt strongly. Bitter peptides in the lipid-containing fraction A are decomposed by performing this step after enzyme treatment step A, and the bitter taste of the soybean-derived composition can be reduced.

As the exopeptidase to be used in the enzyme treatment step B, for example, exopeptidases such as Sumizyme FLAP (produced by SHINNIHON CHEMICALS Corporation), Sumizyme ACP-G (produced by SHINNIHON CHEMICALS Corporation), Protease M “Amano” SD (produced by Amano Enzyme Inc.) and Maxipro CPP (produced by DSM N.V.) derived from genus Aspergillus can be used. The exopeptidase may be used alone or in combination of two or more. Although it is preferable to use only an exopeptidase in the enzyme treatment step B from the viewpoint of decomposing bitter peptides efficiently, a mixture of an exopeptidase and an endopeptidase may be used.

The added amount of the exopeptidase can be appropriately adjusted depending on the type of an exopeptidase to be used or the like. The added amount of the exopeptidase may be, for example, 500 ppm to 3000 ppm based on a liquid obtained by subjecting the lipid-containing fraction A to equivalent dilution.

The treating temperature and treating time of the lipid-containing fraction A in the enzyme treatment step B can be appropriately adjusted depending on the type and the added amount of an exopeptidase to be used or the like, and can be, for example, 50 to 70° C. and 30 to 120 minutes.

The exopeptidase in the lipid-containing fraction B may be deactivated by heating or the like after the enzyme treatment step B if needed. The heating temperature and heating time can be appropriately adjusted depending on the type of the exopeptidase, and can be, for example, 70 to 100° C. and 10 to 120 minutes. The lipid-containing fraction B may be washed by centrifugation or the like after the enzyme treatment step B if needed.

(Centrifugation Step C)

A centrifugation step C is a step of centrifuging the above-mentioned lipid-containing fraction B at 0 to 10° C. to obtain a lipid-containing fraction C. A bitter peptide-containing fraction which is not separated from the lipid-containing fraction B in the enzyme treatment step B (a floating layer and a middle layer) separates by implementing this step, and a lipid-containing fraction C in which the bitter taste is further reduced (precipitation layer) can be obtained as a soybean-derived composition. A lipid-containing fraction B to which water is added may be subjected to the centrifugal treatment step C if needed. The centrifugation step C can be performed once to a plurality of times.

Although the temperature in the centrifugation step C may be 0 to 10° C., it is preferable that the temperature be 4 to 7° C. from the viewpoint that the separation of the lipid-containing fraction B and the bitter peptide-containing fraction is promoted, and the bitter taste is further reduced. The rotation speed and time in the centrifugation step C can be appropriately adjusted, and can be, for example, 2000 to 4000 rpm and 5 to 30 minutes.

(Sterilization Treatment Step)

A sterilization treatment step is a step of subjecting a lipid-containing fraction obtained through the above-mentioned enzyme treatment step A, enzyme treatment step B or centrifugation step C to sterilization treatment. Although the lipid-containing fraction can be used as a soybean-derived composition as it is, the deterioration of the soybean-derived composition can be suppressed by further subjecting the lipid-containing fraction to sterilization treatment. As the sterilization treatment, steam injection treatment or the like can be applied.

(Addition Step)

An addition step is a step of adding an additive to a lipid-containing fraction obtained through the above-mentioned enzyme treatment step A, enzyme treatment step B or centrifugation step C. When the method for producing the soybean-derived composition according to the present embodiment comprises the sterilization treatment step, it is preferable to perform the addition step before the sterilization treatment step. Examples of an additive to be used in an addition step include sweeteners, perfumes, acidulants, antioxidants, emulsifiers, minerals, sugars, oils and fats, fruit juices and vegetable juices.

### EXAMPLES

Hereinafter, the present invention will be further specifically described by way of Examples. However, the present invention is not limited to the following examples.

### Test Example 1: Production and Evaluation of Soybean-Derived Composition (1)

Papain W-40 (produced by Amano Enzyme Inc.) was added to commercial soy milk (trade name: Oishii Muchosei Tounyu, produced by Kikkoman Corporation) at a concentration of 1000 ppm and mixed, and enzyme treatment was performed at 60° C. for 60 minutes. The obtained enzyme-treated product was heated at 100° C. for 10 minutes, then cooled to 20° C. and centrifuged (3000 rpm, 20° C., 10 minutes) to obtain the soybean-derived composition of Example 1 (lipid-containing fraction A, a floating layer).

As to a dry matter obtained by freeze-drying the above-mentioned lipid-containing fraction A of Example 1, the lipid content based on the dried material was measured by extraction with a chloroform and methanol mixed liquid. The lipid content of the soy milk used as a raw material based on dry matter was measured in the same way. The results are shown in Table 1.

TABLE 1

| | Lipid content based on |
|---|---|
| | dry matter |
| | (% by mass) |
| Example 1 | 54.1 |
| Commercial soybean milk | 31.4 |
| (Oishii Muchosei Tounyu) | |

It was confirmed that the lipid content of the lipid-containing fraction A of Example 1 obtained by performing the enzyme treatment step A is increased by concentrating lipids in soy milk.

Two persons performed organic function evaluation as to the oil and fat texture of the above-mentioned lipid-containing fraction A of Example 1 and commercial soy milk cream (trade name: Kokuriimu, produced by FUJI OIL CO., LTD.). Consequently, both persons felt the oil and fat texture of the lipid-containing fraction A of Example 1 more strongly.

### Test Example 2: Preparation and Evaluation of Soybean-Derived Composition (2)

### Preparation of Soybean-Derived Composition of Example 2

Papain W-40 (produced by Amano Enzyme Inc.) was added to soy milk (trade name: Oishii Muchosei Tounyu, produced by Kikkoman Corporation) at a concentration of 1000 ppm and mixed, and enzyme treatment was performed at 60° C. for 60 minutes. The obtained enzyme-treated product was heated at 100° C. for 10 minutes, then cooled to room temperature and further centrifuged (3000 rpm, 20° C., 10 minutes) to obtain the lipid-containing fraction A (floating layer).

Water was added to the above-mentioned lipid-containing fraction A, Sumizyme FLAP (produced by SHINNIHON CHEMICALS Corporation) and Maxipro CPP (produced by DSM N.V.) were added at concentrations of 1000 ppm, respectively and mixed, and enzyme treatment was performed at 50° C. for 60 minutes. The obtained enzyme-treated product was heated at 100° C. for 10 minutes, then cooled to room temperature and further centrifuged (3000 rpm, 20° C., 10 minutes) to obtain a lipid-containing fraction B (upper and middle layers).

The above-mentioned lipid-containing fraction B was centrifuged (3000 rpm, 4° C., 10 minutes) to collect a precipitation layer, water was then further added, and the mixture was centrifuged (3000 rpm, 4° C., 10 minutes) to obtain the soybean-derived composition of Example 2 (lipid-containing fraction C, a precipitation layer).

### Preparation of Soybean-Derived Composition of Example 3

Peeled soybeans (120 g) were immersed in water at 60° C. (480 g) for 1.5 to 3 hours. The immersed peeled soybeans were stirred, mixed with a mixer (trade name: Waring blender 7012S (manufactured by WARING COMMERCIAL); dial 1 to 4) for 10 minutes and then suction-filtered to obtain a suspension.

Papain W-40 (produced by Amano Enzyme Inc.) was added to the above-mentioned suspension at a concentration of 1000 ppm, mixed and enzyme-treated at 60° C. for 60 minutes. The obtained enzyme-treated product was heated at 85° C. for 60 minutes, then ice-cooled and centrifuged (3000 rpm, 4° C., 10 minutes) to obtain a lipid-containing fraction A (floating layer).

Water was added to the above-mentioned lipid-containing fraction A, Sumizyme FLAP (produced by SHINNIHON CHEMICALS Corporation) and Maxipro CPP (produced by DSM N.V.) were added at concentrations of 1000 ppm by mass, respectively and mixed, and enzyme treatment was performed at 50° C. for 60 minutes. The obtained enzyme-treated product was heated at 85° C. for 60 minutes, then cooled to room temperature and further centrifuged (3000 rpm, 30±10° C., 10 minutes) to obtain a lipid-containing fraction B (upper and middle layers).

Water was added to the above-mentioned lipid-containing fraction B, the mixture was centrifuged (3000 rpm, 4° C., 10 minutes) to obtain the soybean-derived composition of Example 3 (lipid-containing fraction C, precipitation layer).

### Preparation of Soybean-Derived Composition of Example 4

Protin NY100 (produced by Amano Enzyme Inc.), Sumizyme BNP (produced by SHINNIHON CHEMICALS Corporation), Peptidase R (produced by SHINNIHON CHEMICALS Corporation), Sumizyme PHY (produced by SHINNIHON CHEMICALS Corporation) were added to soy milk (trade name: Oishii Muchosei Tounyu, produced by Kikkoman Corporation) adjusted to 50° C. at concentrations of 100 ppm, 50 ppm, 100 ppm and 100 ppm, respectively, calcium sulfate was further added at a concentration of 10 mmol, the mixture was mixed, and enzyme treatment was performed at 50° C. for 20 minutes. The obtained enzyme-treated product was heated at 100° C. for 10 minutes, then ice-cooled and further centrifuged (3000 rpm, 4° C., 10 minutes) to obtain the soybean-derived composition of Example 4 (lipid-containing fraction A, precipitation layer).

(Evaluation 1 of Soybean-Derived Composition: Lipid Content and a Lipid Recovery)

As to dry matters obtained by freeze-drying the above-mentioned lipid-containing fractions C of Examples 2 and 3 and lipid-containing fraction A of Example 4, the lipid contents based on the dry matters were measured by extraction with a chloroform and methanol mixed liquid. The lipid recovery from soy milk or a suspension was calculated from the measured lipid content using the following expression. The lipid content of commercial soy milk cream (trade name: Kokuriimu, produced by FUJI OIL CO., LTD.) based on dry matter was measured in the same way. The results are shown in Table 2.

Lipid recovery from soybean milk or suspension (%)=(Amount of lipid in dry matter obtained by freeze-drying lipid-containing fraction (g)/amount of lipid in soy milk or suspension (g))×100

TABLE 2

| | Lipid content based on | Lipid recovery from |
|---|---|---|
| | dry matter | soy milk or suspension |
| | (% by mass) | (%) |
| Example 2 | 80.5 | 15.3 |
| Example 3 | 64.1 | 47.1 |
| Example 4 | 44.8 | 75.7 |
| Commercial soy milk | 57 | — |
| cream | | |

The soybean-derived compositions of Examples 2 and 3 obtained by performing the enzyme treatment step A had a high lipid content as compared with commercial soy milk cream, and especially in the soybean-derived composition of Example 2 wherein soy milk was used as a raw material, the lipid content was more than 80% by mass. The soybean-derived composition of Example 3 using the suspension prepared by adding water to soybeans had around 3 times higher lipid recovery than the soybean-derived composition of Example 2 using soy milk as a raw material, and it was confirmed that lipids can be efficiently recovered from soybeans.

(Evaluation 2 of Soybean-Derived Composition: Sensory Evaluation of Bitter Taste)

Two persons performed sensory evaluation as to the bitter taste of the above-mentioned lipid-containing fraction A, B and C of Example 2 and the above-mentioned lipid-containing fraction A, B and C of Example 3. Sensory evaluation was performed according to 4 ranks (1: bitter taste was not felt; 2: bitter taste was felt slightly; 3: bitter taste was felt; and 4: bitter taste was felt strongly.) and a standard wherein the bitter taste of the lipid-containing fraction A of Example 2 was defined as “4”. The results are shown in Table 3. The evaluations about which the two persons agreed with panels were listed in Table 3.

TABLE 3

| | Fraction B | Fraction C | Fraction A |
|---|---|---|---|
| Example 2 | 2 | 1 | 4 |
| Example 3 | 2 | 1 | 4 |

It was confirmed that bitter taste could be reduced by performing the enzyme treatment step B, and bitter taste could be further reduced by performing the centrifugation step C.

(Evaluation 3 of Soybean-Derived Composition: Analysis of Proteins)

Analysis by SDS-PAGE and Western blotting was performed according to the following procedure as to proteins contained in the above-mentioned suspension and lipid-containing fraction C obtained in Example 3, the above-mentioned lipid-containing fraction A obtained in Example 4, and the above-mentioned commercial soy milk cream.

(1) SDS-PAGE

Each sample liquid was prepared by adding a 50 mM Tris-HCL Buffer (pH 8.5) to each of sample powders obtained by freeze-drying the suspension and the lipid-containing fraction C obtained in Example 3, the lipid-containing fraction A obtained in Example 4, the commercial soy milk cream at a protein concentration of 22% by mass and dissolving each sample powder. The obtained sample liquid (26 μL), an NuPAGE LDS Sample Buffer (4×) (10 μproduced by Invitrogen, Thermo Fisher Scientific K.K.), and an NuPAGE Reducing Agent (10×) (4 μL, produced by Invitrogen, Thermo Fisher Scientific K.K.) were mixed and then heated at 100° C. for 3 minutes. Each obtained mixture was electrophoresed using NuPAGE 4-12% Bis-Tris Protein Gels (1.0 mm, 12 wells) (produced by Invitrogen, Thermo Fisher Scientific K.K.) as migration gel and an NuPAGE MES SDS Running Buffer as a migration buffer under a condition of 200V (constant voltage). Detection was performed by using a stain solution (Imperial Proteins Stain (produced by Thermo Fisher Scientific K.K.)).

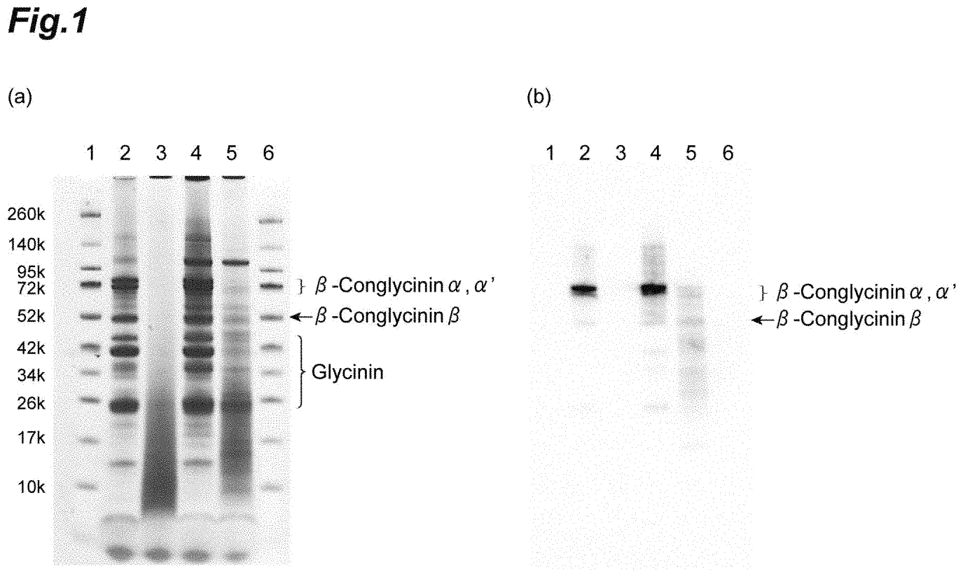

The analysis results by SDS-PAGE are shown in FIG. 1 (a).

(2) Western Blotting

The proteins separated by the above-mentioned SDS-PAGE were transferred to a membrane (Amersham Hybond P PVDF, produced by GE Healthcare) using a Trans-Blot SD Semi-Dry Transfer Cell (produced by Bio-Rad Laboratories, Inc.) as a transfer device and a Bjerrum Schafer-Nielsen Buffer as a transfer buffer under conditions of 15 V and 60 minutes by a semi-dry method. The membrane was subjected to blocking treatment for 60 minutes, and the antigen-antibody reaction was then performed for 2 hours using an enzyme-labeled antibody (FASPEK ELISA II SOYBEAN, produced by Morinaga Institute of Biological Science, Inc.). Detection was performed by chemiluminescence using an Amersham ECL Select Western Blotting Detection Reagent (produced by GE Healthcare) as a detection reagent and a ChemiDoc XRS+(produced by Bio-Rad Laboratories, Inc.) as a detection device.

The analysis results by Western blotting are shown in FIG. 1 (b).

As a result of the analysis by SDS-PAGE, while 3-conglycinin and glycinin were detected in the suspension of Example 3 and the commercial soy milk cream (lane 2 and lane 4 of FIG. 1 (a)), β-conglycinin or glycinin were not detected in the lipid-containing fraction C of Example 3 (lane 3 of FIG. 1 (a)). As a result of the analysis by Western blotting, while β-conglycinin was detected in the suspension of Example 3 and the commercial soy milk cream (lane 2 and lane 4 of FIG. 1 (b)), β-conglycinin was not detected in the lipid-containing fraction C of Example 3 (lane 3 of FIG. 1 (b)).

From the above, it was confirmed that the soybean-derived composition (lipid-containing fraction C) of Example 3 according to the present invention is substantially free of β-conglycinin or glycinin.

### Test Example 3: Effect of Concentrating Lipids with Various Protease

Each protease listed in the following Table 4 was added to soy milk (trade name: Oishii Muchosei Tounyu, produced by Kikkoman Corporation) at a concentration of 1000 ppm, the mixture was mixed, and enzyme treatment was performed under conditions listed in the following Table 4. The obtained enzyme-treated product was heated at 100° C. for 10 minutes, then cooled to 20° C. and centrifuged (3000 rpm, 20° C., 10 minutes). The volume ratio of the lipid-containing fraction A (floating layer) to the whole treated product after centrifugation was calculated. The results are shown in Table 4.

TABLE 4

| | | Classification | | | | |
|---|---|---|---|---|---|---|
| | Source from | by | | Classification | Enzyme | Volume ratio of |
| | which enzyme is | decomposing | Classification | by catalytic | treatment | lipid-containing |
| | derived | position | by substrate | mechanism | conditions | fraction (%) |
| Protin NY | Bacillus | Endo-type | Protease | Metalloprotease | 40° C., 20 | 17 |
| 100 | amyloliquefaciens | protease | | | minutes | |
| Sumizyme P | Carica papaya | Endo-type | Protease | Cysteine | 40° C., 20 | 20 |
| | | protease | | protease | minutes | |
| Bromelain F | Ananas comosus M. | Endo-type | Protease | Cysteine | 45° C., 60 | 10 |
| | | protease | | protease | minutes | |
| Papain W-40 | Carica papaya L. | Endo-type | Protease | Cysteine | 50° C., 60 | 8.3 |
| | | protease | | protease | minutes | |

When all the proteases listed on Table 4 were used, lipid-containing fractions were produced at volume ratios of 8 to 20%, and effects of concentrating lipids with various proteases were confirmed.

1. A soybean-derived composition, wherein a content of lipids as a chloroform/methanol mixed solvent extract is 40% by mass or more based on dry matter, and wherein the composition is substantially free of β-conglycinin.

2. The soybean-derived composition according to claim 1, wherein the composition is substantially free of glycinin.

3. A method for producing a soybean-derived composition, comprising:
a suspension preparation step of adding water to soybeans to obtain a suspension; and
an enzyme treatment step A of treating the suspension with a protease to obtain a lipid-containing fraction A.

4. The production method according to claim 3, wherein the protease is a plant-derived protease.

5. The production method according to claim 3, further comprising an enzyme treatment step B of treating the lipid-containing fraction A with an exopeptidase to obtain a lipid-containing fraction B.

6. The production method according to claim 5, further comprising a centrifugation step C of centrifuging the lipid-containing fraction B at 0 to 10° C. to obtain a lipid-containing fraction C.
